(19) United States
(12) Patent Application Publication
(10) Pub. No.: US 2011/0197492 A1
(43) Pub. Date: Aug. 18, 2011

(54) Fish Attracting and Trolling Lure

(76) Inventor: Lython Eugene Fowler, Longview, TX (US)

(21) Appl. No.: 13/026,782

(22) Filed: Feb. 14, 2011

Related U.S. Application Data
(60) Provisional application No. 61/305,241, filed on Feb. 17, 2010.

(51) Int. Cl. A01K 85/00; A01K 99/00

(52) U.S. Cl. 43/4.5; 43/42.31; 43/42.22

(57) ABSTRACT

A lightweight and maneuverable fish attracting and trolling lure designed for use in trolling or by a stationary caster. The device comprises a planar body surface that is allowed to freely rotate, two extending fins that provide stability and cause lateral movement, an attachment arm with a stopping surface to maneuver the device, a rear attachment pivot that oscillates and provides torque on the bait, and a variable weight positioned near the front of the device. The configuration of the two extending fins, rear attachment pivot, and rotation of the freely rotational arm provides lateral sinusoidal movement, vertical and lateral oscillation, vibration, and noise that is beneficial to attract a number of species of fish.

### CROSS-REFERENCES AND PRIORITY CLAIMS

The present application claims the benefit of Provisional U.S. Application No. 61/305,241, dated Feb. 17, 2010, entitled “Fish Attracting and Trolling Lure,” the disclosure of which is incorporated by reference.

### BACKGROUND

This invention relates to an apparatus that integrates both the effectiveness of trolling and the ease of casting an underwater lure to catch fish. The apparatus is lightweight, has hydrodynamic properties, has a simple and fluid design, and can easily be controlled by a fisherman by trolling or by stationary casting. The unique movement created by the design creates movement, vibration, and noise which are effective and useful for catching numerous species of fish.

Trolling is a popular method of catching fish and is generally divided into two categories of planars: side planars and depth planars. The current invention incorporates certain elements of depth planars. Depth planars use a device, often referred to as a planar, having hydrodynamic properties pulling a lure and diving to a predetermined depth and being pulled at a given horizontal depth behind the boat. The precision of the design, placement of the center-of-gravity, weight, and hydrodynamic features govern how the device will behave underwater as well as its effectiveness to catch fish. Often fishermen wish to troll at certain depths in order to catch the correct species of fish. Seasonal and climate conditions also determine the desired depth of the planar. However, a need arises for the planars to be easily controlled yet still attract fish. Fish are commonly attracted to underwater bodies that produce vertical and lateral movement, as well as vibrations and noise.

The amount of force exerted by the fisherman required to change the depth of planars sufficient to change depth is substantial to overcome the drag of the device moving through the water. Certain planars attempt to overcome this problem through the use of buoyant attachments and other modifications to the planar. The buoyant attachments and modifications add to the drag of the planar and reduce its maneuverability. The result is that planars have to be towed by a boat at a static depth and continuous speed. Additionally, other planars do not allow the device to freely move due to their configuration and restrictive properties. Such planars rely on the lure being towed to create the attractive properties of the device. Furthermore, a situation may exist where stationary casting is preferred over trolling. Therefore, there is a need for a lightweight, easily controlled device that produces underwater movement attractive to fish yet is still able to glide through the water.

### SUMMARY

The present invention is directed to an apparatus that satisfies this need for a lightweight, easily controlled device that produces underwater movement attractive to fish. The current invention comprises a planar body surface with two extending fins, a solid freely rotating attachment pivot for the attachment to a line, which is connected near the center of the planar body surface, a rear attachment pivot for attachment of the lure, which is connected to the rear of the planar. The planar body surface contains a plurality of holes for the attachment of a weighted device near the front of the planar body surface, as well as attachment of the freely rotating attachment arm and rear attachment pivot.

### DESCRIPTION OF THE DRAWINGS

These and other features, aspects and advantages of the present invention will become better understood with regard to the following description, appended claims, and accompanying drawings where:

FIG. 1 shows a perspective view of an embodiment of the invention;

FIG. 2 shows a side elevational view of an embodiment of the invention of FIG. 1;

FIG. 3 shows a front view of an embodiment of the invention of FIG. 1;

FIG. 4 shows a top view of an embodiment of the invention of FIG. 1;

FIG. 5 shows a top view of an embodiment of the invention of FIG. 1 illustrating the lateral sinusoidal motion.

### DESCRIPTION

### Overview

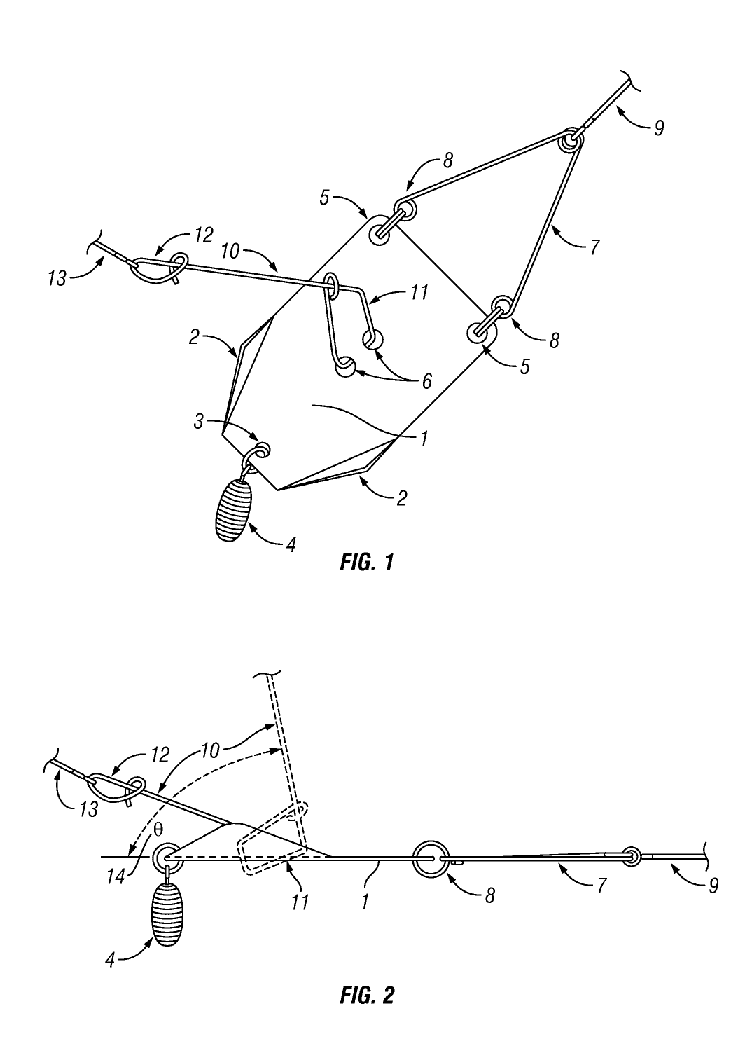

An embodiment of the invention is shown in FIG. 1, the device comprises a planar body surface where the front edge is of narrower width than the back edge 1, with two extending fins in which the fins form a dihedral angle with the plane of the planar body surface 2, a solid freely rotating attachment arm 10, for the attachment to a line 13, which is connected near the center of the planar body surface, a rear attachment pivot 7, for attachment of the line and lure 9, which is connected to the rear of the planar body surface. The planar body surface contains a plurality of holes 3, 5, 6, for the attachment of a weighted device 4, near the front of the planar body surface, as well as attachment of the freely rotating attachment arm and rear attachment pivot. The freely rotating attachment arm further comprises a stopping surface 11, such that the entire device is unable to pitch downward and opposite the direction of forward movement. The freely rotating attachment arm further comprises an eyelet 12, for attachment to a fishing line. The rear attachment pivot is attached to the planar body by an attachment means 8, allowing the rear attachment pivot to freely rotate.

### DETAILED DESCRIPTION OF THE ELEMENTS

As may be appreciated by the drawings, the planar body surface 1, provides the vertical hydrodynamic stability as the device glides through the water. The shape of the planar body surface is substantially flat, with the front leading edge being narrower than the back edge. This configuration also allows the device to change depth with less resistance, as the lessened surface area of the front portion reduces hydrodynamic resistance and drag. The planar body surface may be manufactured of a number of suitable materials, although solid resilient materials such as metal that are resistant to stress and strain are preferred.

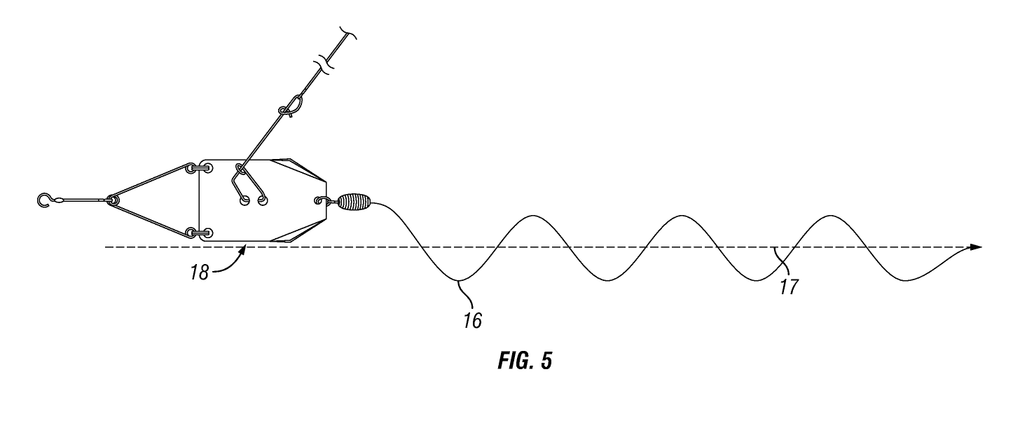

The two extending wings 2, provide further stability for the device. The wings are configured such that they form a dihedral angle with the planar body surface. This allows the wings to extend along both the vertical and horizontal axes relative to the planar body surface. The wings are attached to the planar body surface near the front edges of the planar body surface. Extending the wings in this configuration minimizes the drag while maintaining vertical and lateral stability. Additionally, this configuration also contributes to the lateral motion of the device, as illustrated in FIG. 5. It is optimal to manufacture the wings of a solid resilient material such as that of the planar body surface.

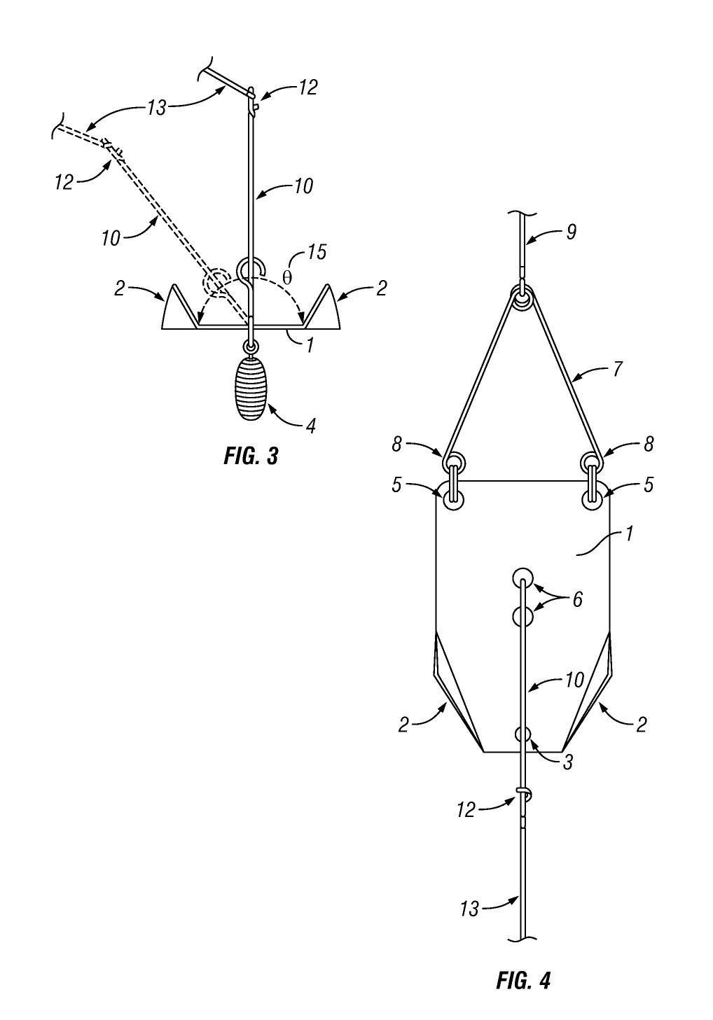

The solid freely rotating arm 10, is connected to the planar body surface, and also to the line. The solid freely rotating arm allows the planar body surface to rotate both laterally and vertically. As illustrated in FIG. 2, the solid freely rotating arm is attached such that it will rotate radially forward by an angle 14, in relation to the planar body surface. As illustrated in FIG. 3, the solid freely rotating arm is also attached such that it will rotate radially side-to-side by an angle 15, in relation to the planar body surface. The freely rotating attachment arm is attached to the planar surface body, near the center of said planar body surface. The attachment of the freely rotating arm in this position configures the center-of-gravity for the device near the point of attachment. The result is that the direction of motion and rotation can be controlled by the caster.

The solid freely rotating arm 10, is attached to the planar body surface and such a manner that allows it to freely rotate. It is preferable to attach the freely rotating arm through a set of holes 6, placed near the center of the planar body surface. It is desirable to manufacture the freely rotating arm out of a strong resilient material, similar to that of the planar body surface. The freely rotating arm further comprises an eyelet 12, for attachment to a line 13. Additionally, the freely rotating arm further comprises a stopping surface, 11. The stopping surface prevents the freely rotating arm from over-rotation. As illustrated in FIG. 14, as the angle of rotation 14, of the freely rotating arm increases in relation to the planar body surface 14, the greater the angle between the line and the planar body surface. It is desirable to prevent this angle from becoming too large, as the front of the planar body surface would be tipped radially forward opposite the direction of forward motion. The result would be that the device would tip over and lose control. The stopping surface is shaped in such a manner to prevent over-rotation. The preferred shape of the stopping surface is flat, and angled in such a matter as to prevent over-rotation as illustrated in FIG. 2. It is desirable that the stopping surface would be made of a strong resilient material such as metal.

The rear attachment pivot 7, is attached to the rear of the planar body surface. As the planar body surface glides forward through the water, the rear attachment pivot oscillates vertically, creating movement that is attractive to fish. The rear attachment pivot is substantially flat and attached to the planar body surface by an attachment means 8, allowing it to freely rotate. The attachment means serves to fasten the attachment pivot to the rear of the planar body surface without restricting its rotation. The fastening means could be rings, levers, pivot joints, wire, soft rubber, or ball bearings and housing structures. It is preferred that the fastening means be small rings inserted through a hole or holes 5, near the rear of the planar body surface. A lure 9, is attached to the rear of the rear attachment pivot. It is preferable that the rear attachment pivot is of definite shape, and is substantially flat and planar. It is optimal that a strong resilient material such as that used in the planar body surface be used for the construction of the rear attachment pivot.

A weight 4, may be attached to the front of the device to configure the underwater behavior of the planar body surface. The weight may be of different loads and configurations as desirable by the caster. The weight is attached to the planar body surface through hole or set of holes 3, near the front of the planar body surface. It is preferable to attach the weight to the planar body surface by a small ring. The weight may be of metal, lead, hard plastic, or other material chosen by the caster.

### HOW THE INVENTION IS USED

The previously described version of the present invention has many advantages including: a lightweight and hydrodynamic design; a freely rotating arm that allows lateral and vertical rotation; maneuverability and ability to change depths without recasting; and a body surface that produces motion, rotation, vibration and noise such as to attract fish. The invention can be used in numerous different ways. One such way is to drop or cast the device behind a moving boat for trolling.

The device will be pulled by the boat at an underwater depth. The caster may change the depth of the device by a simple reeling motion. The device has a low drag profile, such that the downward resistance easily allows a change in depth. If a fish catches the bait being towed, the center-of-gravity of the device will shift to the rear of the device. This will cause the freely rotating arm to rotate radially towards the front of the planar body surface, such that the angle 14, between the freely rotating arm and the planar body surface is near zero degrees (0°). Therefore, the drag is minimized in reeling in a fish.

Previous planars relied on the lure or bait in tow to attract fish. The unique movement of the present device has provided a movement that has proven to be attractive to numerous species of fish. As the device moves forward, water current flows against the front edges of the two extending fins and through the space between the two extending fins and the planar body. The current causes the planar body surface to laterally rotate first in one direction as the freely rotating arm rotates opposite, such that the angle 15, is changing with forward motion of the device. The freely rotating arm then reaches its apex of movement and both the planar body surface and the freely rotating arm move in their respective opposite directions. As illustrated in FIG. 5, this process repeats itself as the device 18, moves forward and creates a movement similar to sinusoidal movement 16, in relation to the lateral axis 17.

Other underwater movement is created by the device. As the device moves forward, the rear attachment pivot oscillates vertically in relation to the planar body surface, and the added torque of the length of the rear attachment pivot causes the bait to experience oscillating vertical movement. Additionally, the lateral oscillations of the device cause the planar body surface to vibrate rapidly. The movement of the freely rotating arm also strikes the planar body surface, creating a sound that attracts fish.

Another way of using the device is through stationary casting. The device may be cast by a fisherman and reeled in shallow or deep water. The device's configuration and lightweight properties allow this to be accomplished with little drag. The movements, vibrations and sound are still present as they are in trolling.

One use of the device is to cast the device into water and let the device descend near the bottom. The caster then reels in the device so that the front of the device glides towards the top of the water. This use can be repeated many times by a stationary caster, and has proven to be a highly efficient way of catching fish.

Use of the device is not limited to specified depths and water conditions. The device may be used in shallow or deeper waters. The device may also be used in either freshwater or saltwater conditions. Different weights or sizes of the device may be used in accordance with the type of fish desired to be captured.

### Specific Embodiments and Examples

An example of an embodiment of the current invention is described in FIG. 1 and is further described as the preferred design and best mode for carrying out the invention. The planar body surface 1, of the embodiment is constructed from a lightweight aluminum alloy and serves as the “base”. The planar body surface is flat and has a specific shape, being a polygon with six (6) sides. Three of the sides intersect at ninety degree)(90°) angles, with one side being designated the “rear side”. The other two sides are designated “back lateral sides”. The back lateral sides are parallel to each other and are of equal length.

The remaining three sides intersect at acute angles. One such side being designated the “front side” and being parallel to the rear side. The other two sides are designated the “front lateral sides” and are of equal length. The front side is located between the front lateral sides. The shape of the planar body surface is symmetrical.

The two extending fins 2, are shaped like a scalene triangles, and are made out of the same sheet of aluminum alloy as used in the planar body surface. The two extending fins extend from the edge of the front lateral sides of the base. Each upwardly facing fin forms an acute angle with the base of approximately 45 degrees) (45°). The base of each fin being the exact distance of the front lateral sides. The two extending fins are made of the same sheet of aluminum alloy as the base.

A hole 3, is present through the base, located near the front of the device. The hole is centered with the front side and is equidistant from the edges of the back lateral sides. A small lead weight 4, commonly used on fishing lures is attached to the hole.

An additional pair of holes 6, is present through the base, located near the center of the base. The pair of holes is horizontally spaced in such a manner that is equidistant from the edges of the back lateral sides. The holes are vertically spaced in such a manner that they a distance of approximately one-half (½) of the total length of the base from the edge of the front side.

An additional set of holes 5, are present through the base, located near the edge of the back lateral sides. The set of holes are vertically spaced in such a manner that they are a distance of not more than one-fourth (¼) of the total length of the base from the edge of the rear side.

The freely rotating arm 10, is a solid resilient piece of aluminum alloy wire. The wire is bent such that it forms the stopping surface 11, then forms an angle of greater of ninety (90) degrees and extends upward a distance of approximately the length of the base. The wire is looped through the center two holes in the base. The wire is then bent at its end such that it forms the eyelet, 12. Fishing line 13, is connected to the eyelet. The fishing line leads to the fishing pole, controlled by the caster.

The rear attachment pivot 7, is a solid piece of aluminum alloy wire. The wire is shaped like a “V”. The wire is attached to the rear of the base through the two rear holes, 5. Small metal rings 8, which are looped through the holes adjoin the wire to the base. A fishing line 9, is attached to the point of the “V” shaped wire which is attached to the bait and lure.

### ALTERNATIVES

Although the present invention has been described in considerable detail with reference to certain preferred versions thereof, other versions are possible. For example, the rear attachment pivot may be substantially solid as opposed to a thin “V” shaped wire. The goal of this feature is to apply torque to the bait in tow and create motion similar to the motions of swimming fish. Therefore, the spirit and scope of the appended claims should not be limited to the descriptions of the preferred versions herein.

Any element in a claim that does not explicitly state “means for” performing a specified function, or “step for” performing a specific function, is not to be interpreted as a “means” or “step” clause as specified in 35 U.S.C. §112, ¶ 6. In particular, the use of “step of” in the claims herein is not intended to invoke the provisions of 35 U.S.C. §112, ¶ 6.

What is claimed is:

1. A fish attracting and trolling lure, comprising:
a. a planar body surface;
b. a means for inducing lateral sinusoidal oscillation and vibration of said planar body surface;
c. a means for planar body surface rotation, adapted to connect said planar body surface to a fishing line, in which said means for planar body surface rotation allows said planar body surface to rotate; and
d. a rear attachment pivot adapted to connect said planar body surface to a bait and hook, in which said rear attachment pivot is capable of oscillation.

2. The apparatus of claim 1, wherein said planar body surface is shaped as a polygon with six sides.

3. The apparatus of claim 2, wherein said planar body surface is substantially flat, with the front leading edge being narrower than the back edge.

4. The apparatus of claim 3, wherein said planar body surface has three sides which intersect at ninety degree angles (90°), three sides which intersect at acute angles, and wherein said planar body surface is symmetrical.

5. The apparatus of claim 1, wherein a plurality of holes is present in said planar body surface.

6. The apparatus of claim 1, wherein said means for inducing lateral sinusoidal oscillation and vibration of said planar body surface comprises two extending fins, in which the two extending fins form a dihedral angle with the plane of said planar body surface.

7. The apparatus of claim 6, wherein said extending fins extend from the edge of the front lateral side of said planar body surface.

8. The apparatus of claim 7, wherein said extending fins are shaped like scalene triangles.

9. The apparatus of claim 8, wherein said extending fins forms an acute angle with said planar body surface of approximately 45 degrees (45°).

10. The apparatus of claim 1, wherein said means for planar body surface rotation comprises a solid freely rotating attachment arm attached to said planar body surface.

11. The apparatus of claim 1, wherein said solid freely rotating attachment arm is connected to said planar body surface near the center-of-gravity of said planar body surface.

12. The apparatus of claim 11, wherein said solid freely rotating attachment arm is capable of free rotation.

13. The apparatus of claim 12, wherein said freely rotating attachment arm allows vertical and lateral rotation of said planar body surface.

14. The apparatus of claim 13, wherein the lateral and vertical rotation of said freely rotating attachment arm allows a caster to control roll, pitch, and yaw of said planar body surface according to the current invention.

15. The apparatus of claim 10, wherein said freely rotating attachment arm further comprises a stopping surface to prevent over-rotation of said freely rotating attachment arm according to the current invention.

16. The apparatus of claim 10, wherein said freely rotating attachment arm further comprises an eyelet for attachment to a fishing line.

17. The apparatus of claim 1, wherein said rear attachment pivot is connected to the rear of said planar body surface.

18. The apparatus of claim 17, wherein said rear attachment pivot is substantially flat.

19. The apparatus of claim 18, wherein said rear attachment pivot is capable of vertical oscillation.

20. The apparatus of claim 18, wherein said rear attachment pivot is a solid wire shaped like a “V”, which is attached to bait and a lure.

21. The apparatus of claim 19, wherein vertical oscillation of said rear attachment causes said rear attachment pivot to strike said planar body surface, producing noise audible to underwater fish.

22. The apparatus of claim 1, wherein a weight may be attached to the front of said planar body surface.

23. A trolling apparatus configured to provide lateral sinusoidal movement, vertical and lateral oscillation, vibration, and noise that is beneficial to attract a number of species of fish, comprising:
a. a lightweight and hydrodynamically stable planar body surface, capable of free rotation;
b. two extending fins that provide stability and cause lateral movement of said planar body surface;
c. an attachment arm with a stopping surface to maneuver said trolling apparatus; and
d. a rear attachment pivot.

24. A method of catching fish involving stationary casting of a depth planar, comprising:
a. casting a lightweight depth planar into a body of water through the use of a fishing pole from a stationary position;
b. allowing the weight of said lightweight depth planar to descend to a desired depth;
c. reeling in said lightweight depth planar so that said lightweight depth planar vertically and hydronamically ascends at a desired speed to attract fish; and
d. repeating said method of catching fish until a fish is caught.
